(19) United States
(12) Patent Application Publication
(10) Pub. No.: US 2026/0117856 A1
(43) Pub. Date: Apr. 30, 2026

(54) SHAFT-HUB CONNECTION FOR A TRANSMISSION

(71) Applicant: Flender GmbH, Bocholt (DE)

(72) Inventors: MICHAEL VENNEMANN, Bocholt (DE); SABRINA SPERL, Bocholt (DE); CHRISTIAN KÖNIG, Bocholt (DE)

(73) Assignee: Flender GmbH, Bocholt (DE)

(21) Appl. No.: 19/151,904

(22) PCT Filed: Jan. 29, 2024
(86) PCT No.: PCT/EP2024/052055

§ 371 Date: Jul. 29, 2025

(30) Foreign Application Priority Data
Jan. 30, 2023 (EP) 23153982.6

(51) Int. Cl. F16H 57/04; F03D 15/10; F03D 80/70

(52) U.S. Cl. CPC F16H 57/043; F03D 15/101; F03D 80/707; F16H 57/0486; F05B 2220/706; F05B 2260/40311; F05B 2260/98

(57) ABSTRACT

A shaft-hub connection for a planetary transmission includes an inner hub element and an outer hub element which is connected via a spline toothing in driving relationship with the inner hub element about a main axis of rotation and surrounding the inner hub element at an outer circumference. The inner hub element and the outer hub element bear against one another via a pairing of axial contact surfaces. An oil channel is formed by the inner hub element in a region of an axial position of the axial contact surfaces for oiling of the axial contact surfaces and opens out radially within the axial contact surfaces via an outlet mouth.

The invention relates to a shaft-hub connection for a planetary transmission, having an inner hub element, an outer hub element which is connected in terms of drive to the inner hub element about a main axis of rotation A_{R} via a spline toothing and surrounds the inner hub element at the outer circumference, wherein the inner hub element and the outer hub element bear against one another via a pairing of axial contact surfaces. The Invention furthermore relates to a transmission having a shaft-hub connection.

Wind-turbine transmissions generally contain planetary transmissions which may be designed with one or more planetary stages. The toothings of the planetary transmissions are generally of helically toothed design. The helical toothing results in axial forces within a planetary stage which, in the stage that follows in relation to the flow of force, have to be supported. There are different configurations for the planetary transmissions and the stages. In a first configuration, it may be provided for example that, In a planetary stage, the output is via the sun gear or via a corresponding sun shaft that is mounted radially in a running toothing with respect to the planet gears and in a spline toothing with respect to a following component, for example a hollow hub element of a spur-gear stage. In this case, the sun shaft, in terms of structure, is the inner hub element, while the hollow hub element is an outer element and may be designed as a hollow shaft. A setup in which the outer hub element drives a subsequently arranged generator directly, that is to say without Interposition of a spur-gear stage, is also possible. In a further configuration of the planetary stages, the arrangement of the inner and outer hub elements is for example such that the sun shaft or the sun gear of a planetary stage is configured to be an outer hub element and the inner hub element is designed as a hollow shaft for driving the planetary stage that follows. The inner hub element may, for example, be connected in terms of drive to the planet carrier of the following stage directly or indirectly.

The axial mounting of the one hub element for supporting the axial forces introduced in a main force direction is normally realized via an abutment shoulder of said hub element, which abutment shoulder is supported against a corresponding abutment shoulder of the other hub element. The corresponding abutment shoulders are in this case in contact with one another via a pairing of axial contact surfaces. An abutment shoulder may also be referred to as a shaft collar or shaft shoulder. Depending on the magnitude of the axial forces and displacements of the components involved, wear can occur on the axial contact surfaces, wherein it is in principle possible for wear to be counteracted by oiling of the axial contact surfaces during operation. One possibility is to direct the oil through the spline toothing between the two hub elements in the axial direction and to feed said oil to the axial contact surfaces. This involves passive feeding of oil that is limited in particular in operating conditions with high rotational speeds. Since the direct point of feeding of the oil to the axial contact surfaces is in principle situated radially outside the axial contact surfaces, the prevailing centrifugal force drives the oil outward and prevents oil from being able to pass radially inward to the axial contact surfaces to a sufficient extent. Another possibility is described in DE 10 2013 217 950 A1, which resolves the described shortcomings of the passive feeding of oil by way of pressure lubrication, which actively conveys lubricating oil to the axial contact surfaces via oil-guiding channels. Such pressure lubrication can be regarded as being detrimental from the aspects of outlay and costs. There is a constant need to simplify and improve the oiling of the axial contact surfaces. Furthermore, mention should be made of CN 102 312 928 A as prior art.

It is the object of the invention to specify measures that allow simplified and improved oiling.

The object is achieved by a shaft-hub connection for a planetary transmission that has the features of claim 1. Preferred configurations are specified in the dependent claims and in the following description and may in each case individually or in combination represent an aspect of the invention. If a feature is presented in combination with another feature, this serves only for simplified presentation of the invention and is in no way intended to mean that said feature cannot also be a refinement of the invention without the other feature.

One embodiment relates to a shaft-hub connection for a planetary transmission that comprises an inner hub element, an outer hub element which is connected in terms of drive to the inner hub element about a main axis of rotation AR via a spline toothing and surrounds the inner hub element at the outer circumference, wherein the inner hub element and the outer hub element bear against one another via a pairing of axial contact surfaces, wherein the inner hub element forms in the region of the axial position of the axial contact surfaces at least one oil channel for oiling of the axial contact surfaces, said at least one oil channel opening out radially within the axial contact surfaces via an outlet mouth.

In the present case, the main axis of rotation A_{R} defines the axial direction, so that the respective radial directions result from this axial direction. The respective axial positions of the axial contact surfaces and of the at least one radially extending oil channel of the inner hub element thus substantially coincide. Strict coincidence of the axial positions of the axial contact surfaces and the oil channel(s) in the geometrical sense is not absolutely necessary.

The outer hub element may be designed as a hollow shaft or as a sun shaft or sun gear according to the underlying configuration. The spline toothing connecting the inner and outer hub elements to one another in a form-fitting manner for the purpose of transmitting a torque may be referred to as a short toothing. The short toothing may be of helically toothed design. The hub elements may be mounted via bearing arrangements, for example with respect to a transmission-housing structure, wherein one of the bearing arrangements is configured to absorb or support axial forces.

The oil channel is a passage bore which extends from an inner circumferential surface of the inner hub element as far as an outer circumferential surface. It is not absolutely necessary for the oil channel to have a round cross section; it may also be oval, polygonal or slot-shaped in cross section. The number of oil channels may vary according to application. It is expedient for the respective number of oil channels to be spaced apart evenly over the circumference of the inner hub element.

The inner hub element, preferably of hollow form, can centrally accommodate therein a pitch tube through which electrical lines are routed. Between the pitch tube and an inner circumference of the hub element, provision is made of a circumferential volume in which oil is held, or into which oil can flow during operation, so that said oil is driven through the oil channel(s) via the centrifugal forces that act during operation.

In the described configuration of the shaft-hub connection, for oiling the axial contact surfaces, the lubricating oil does not have to work against the centrifugal force in order to pass to the axial contact surfaces, as is the case with conventional solutions for lubricating the axial contact surfaces. Rather, the centrifugal force assists with the passage of oil to the axial contact surfaces. The service life of the axial contact surfaces can be lengthened by the more targeted and improved introduction of the lubricant radially within the axial contact surfaces.

In one refinement, which particularly promotes the take-up of oil through the oil channels, the oil channels open out in a geometry which extends circumferentially on an inner circumferential surface of the inner hub element. The geometry may be in the form of a recess, a groove, a shoulder, or a depression formed in some other way, with respect to the inner circumferential surface. The inner circumference of the hub element has a larger diameter in a base of the geometry than adjacent thereto. The oil, due to the centrifugal force prevailing during operation, is collected particularly effectively via or in the geometry and can also be held there before flowing away radially outward through the oil channels proceeding from the geometry, in order to pass to the axial contact surfaces, and oiling and lubricating the latter. The inner-circumferential geometry entails no structural weakening of the hollow shaft since, during operation, the torque flow is already passed beforehand to the hub element via the spline toothing. The geometry is not within the range of the torque flow.

Since, in a specific embodiment, the axial contact surface of the inner hub element is formed on a radial shoulder of said hub element, it may be provided in an advantageous embodiment that the oil channels open out in the region of the radial shoulder. A foot region may be provided as an opening-out region, for example. In this way, it is possible in a simple manner for the oil, by way of the centrifugal force prevailing during operation, to be centrifuged further radially outward, or to be driven outward on the radial shoulder, directly onto the axial contact surface or between the pairing of axial contact surfaces of the inner and outer hub elements.

In a further preferred configuration, provision is made for a seal to be provided between the inner hub element and the outer hub element with an axial offset from the oil channels. In particular, the seal is positioned in such a way that the oil channels are positioned between the axial contact surfaces, at one side, and the seal, at the other side, so that, after the lubricating oil has exited the oil bores, it necessarily has to flow away over the axial contact surfaces. The sealing may be realized for example via an O-ring or else a plastic bushing inserted between the inner and outer hub elements.

In an advantageous embodiment of the axial contact surfaces, it is provided that a surface profiling is applied at least to one of these surfaces. In this way, it is achieved that a certain amount of lubricating oil can be kept as reserve in the oil grooves, this continuing to provide for lubrication in operating situations in which replenishment of lubricating oil via the oil channels is reduced. In this case, the surface profiling may be formed in such a way that at least one of the axial contact surfaces is designed with a central crowning. Alternatively, the axial contact surfaces may also be positioned in a cone-shaped manner or conically with respect to one another.

In a first possible configuration, the radial shoulder or abutment shoulder is formed in an integral manner from the inner hub element, specifically in such a way that the hub element is machined at one end, for example by turning, and the radial shoulder extends between the machined diameter and the adjoining diameter. This configuration is advantageous in particular if the main force direction determined by the axial force is directed toward the machined shaft end.

In a further possible configuration, the radial shoulder is formed by an abutment ring which is attached coaxially to the Inner hub element at one end. In this case, the radial shoulder extends between a diameter of the shaft end and a correspondingly larger diameter of the abutment ring. This configuration is advantageous in particular if the main force direction determined by the axial force is, proceeding from the shaft end that bears the abutment ring, directed along the shaft. In terms of manufacturing, it may be provided that the abutment ring is held on the hub element at one end via a screw connection, This multi-part setup results in the advantageous possibility of the oil channels being formed by recesses which extend radially on an end face of the hub element and/or on an end face of the abutment ring. Furthermore, it may in this case be provided that the oil channels and the recess encircling on an inner circumferential surface of the hub element are arranged in a separation plane between the hub element and the abutment ring, thus resulting in a further simplification in terms of manufacturing.

The object is moreover achieved by a transmission for a wind turbine that consists of at least one planetary stage and of an outer hub element which is connected in terms of drive to the at least one planetary stage, wherein at least one drive connection between multiple planetary stages and/or between the at least one planetary stage and the outer hub element is realized as a shaft-hub connection as described above. In particular, it may in this case be provided that the following planetary stage rotates more rapidly than the preceding planetary stage.

The object is also achieved by a drive train for a wind turbine that comprises a rotor shaft, which is connected in a torque-transmitting manner to a transmission, and a generator, which is connected in a torque-transmitting manner to the transmission, wherein the transmission is designed as described above. In addition, the planetary transmission and the generator may also be integrated one inside the other, that is to say designed as a generator transmission.

Likewise, the underlying object is achieved by a wind turbine that comprises a nacelle on which a multi-blade rotor is arranged in a rotatable manner, said multi-blade rotor being connected in a torque-transmitting manner to a drive train, wherein the drive train is designed as described above.

The underlying object is moreover achieved by a data agglomerate with data packets combined in a common file or distributed among different files for depicting the three-dimensional design and/or the interactions of all the constituent parts provided in a shaft-hub connection as described above, wherein the data packets are prepared for carrying out, during processing by a data-processing device, additive manufacturing of the constituent parts of the shaft-hub connection, in particular by 3D printing by means of a 3D printer, and/or for simulation of the functioning of the shaft-hub connection. This makes possible inexpensive production of prototypes and/or computer-based simulations in order to study the functioning of the shaft-hub connection, to identify problems in the specific application, and to find improvements. The data model may also be suitable for simulating fluid-dynamic behavior of an operating medium, such as for example a lubricant.

Below, the invention will be explained by way of example with reference to the appended drawings on the basis of preferred exemplary embodiments, wherein the features presented below may in each case individually or in combination represent an aspect of the invention. In the drawings:

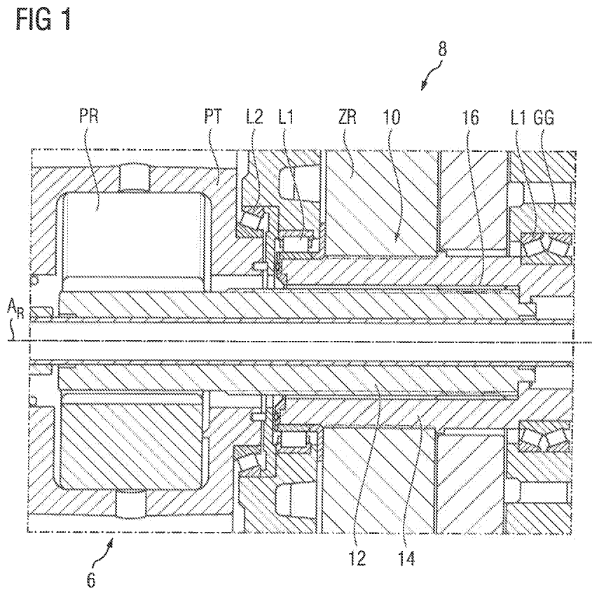

FIG. 1 shows a first variant of a structural setup of a shaft-hub connection;

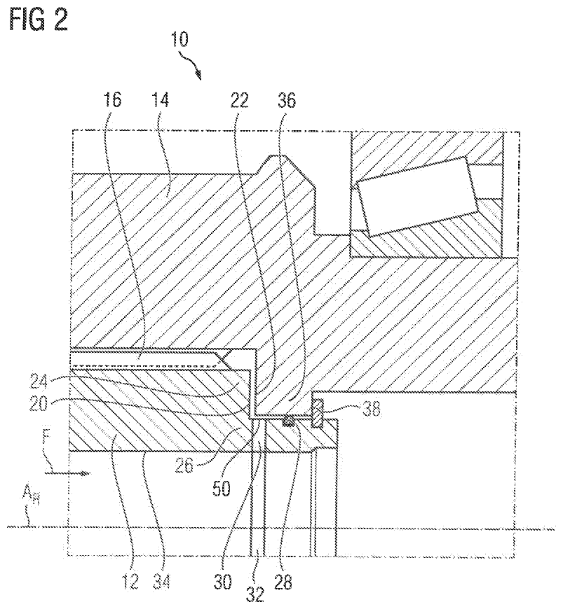

FIG. 2 shows a detail of the shaft-hub connection as per FIG. 1;

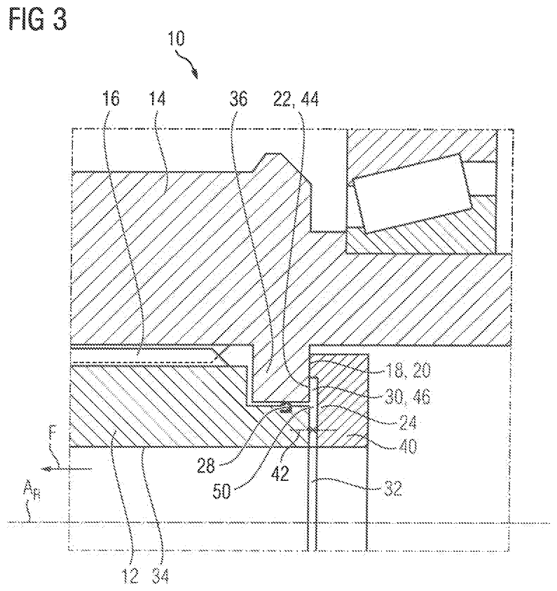

FIG. 3 shows an alternative configuration of a shaft-hub connection;

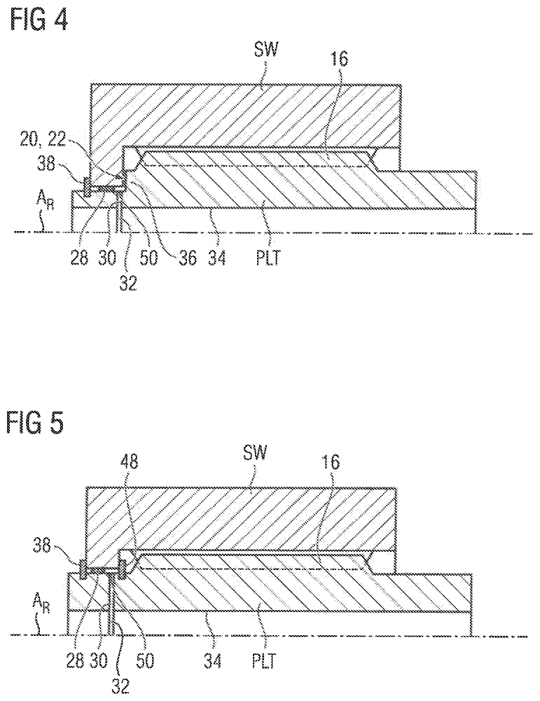

FIG. 4 shows a second variant of a structural setup of a shaft-hub connection;

FIG. 5 shows an alternative embodiment of the variant as per FIG. 4;

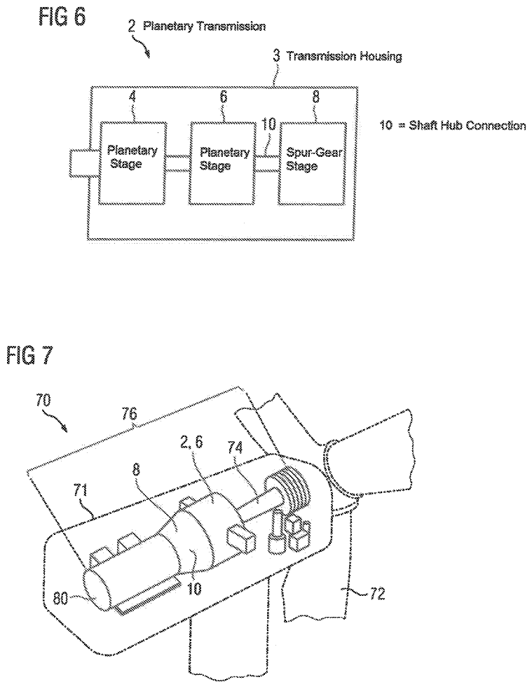

FIG. 6 shows a planetary transmission in a drive train for a wind turbine, and

FIG. 7 shows a perspective illustration of a wind turbine.

FIG. 1 shows a structural setup of a possible configuration of a shaft-hub connection 10, the details of which will be described below on the basis of the further figures. The shaft-hub connection 10 is provided in the present case as a drive connection between a planetary stage 6 and a spur-gear stage 8. Of the planetary stage 6, only a planet-gear carrier PT and the toothing engagement of planet gears PR with an inner hub element 12 are shown, wherein the inner hub element 12 is designed as a sun shaft. Of the spur gear stage 8, only an outer hub element 14, which is designed as a hollow shaft, and a gear ZR, which is connected in a rotationally conjoint manner to said outer hub element, are shown. If no spur-gear stage 8 is provided, the outer hub element 14 may be connected in terms of drive at least indirectly to a generator (not illustrated). The outer hub element 14 is mounted via a bearing arrangement L1 with respect to a transmission housing GG. Axial forces introduced into the outer hub element 14 can be supported via the bearing arrangement L1. The Inner hub element 12 is mounted on the one hand via a spline toothing 16, via which the inner hub element 12 is connected in terms of drive to the outer hub element 14 arranged on the outer circumference. On the other hand, the inner hub element 12 is mounted indirectly via a bearing arrangement L2 of the planet-gear carrier PT in the transmission housing GG. A rotation of the two hub elements 12, 14 can take place about a main axis of rotation A_{R}. The inner hub element 12 or the sun shaft is designed as a hollow shaft. This offers, in an application in which the shaft-hub connection 10 is used, for example in a planetary transmission for a wind turbine, the possibility of allowing a non-co-rotating pitch tube to run within the sun shaft 12. The outer hub element 14 is also designed in the present case as a hollow shaft.

FIG. 2 shows a detail of the shaft-hub connection 10, in particular of the region in which an axial force acting on the inner hub element 12 is supported at the outer hub element 14. To make things clear, a main force direction of the axial force is indicated by the arrow F. The axial force is generated during operation by the planetary stages, which are designed with a helical toothing. In the present case, the angle of the helical toothing is configured in such a way that the main force direction F of the axial force in the illustration in FIG. 2 is oriented from left to right. The inner hub element 12 and the outer hub element 14 bear against one another via a pairing of axial contact surfaces 20, 22. The axial force introduced into the inner hub element 12 during operation is supported via the axial contact surfaces 20, 22. Despite the form-fitting connection between the two hub elements 12, 14 via the spline toothing 16, relative movements between the axial contact surface 20 of the inner hub element 12, at one side, and the axial contact surface 22 of the outer hub element 14, at the other side, occur. In order to counteract wear resulting in this way or at least to substantially reduce it, provision is made for oiling of the axial contact surfaces 20, 22.

The inner hub element 12 forms a radial shoulder 24 on which the axial contact surface 20 is situated. The outer hub element 14 forms a corresponding radial shoulder 36 on which the axial contact surface 22 is situated. The two axial contact surfaces 20, 22 expediently extend in a radial direction in relation to the main axis of rotation A_{R}. The position of the two radial shoulders 24, 36 results in a direction of fitting of the inner hub element 12 into the outer hub element 14 which is the same as the main force direction F. For axial support of an axial force directed opposite the main force direction F in a reversing operation of the planetary stage, a securing ring 38 is held on the inner hub element 12. The securing ring 38 supports the hub element 12 with respect to a flank of the radial shoulder 36 that is at the rear in relation to the axial contact surface 22.

The inner hub element 12 forms in the region of the axial position, in relation to the main axis of rotation A_{R}, of the axial contact surfaces 20, 22 of the two radial shoulders 24, 36 multiple circumferentially distributed and radially directed oil channels 30 for oiling of the axial contact surfaces 20, 22. The oil channels 30 may be designed as oil bores, for example with a round cross section. It can be seen that the oil channels 30 open out radially outward via an outlet mouth 50 directly or at least approximately in a foot region 26 of the radial shoulder 24. The oil channels 30 open out radially inward at an inner circumferential surface 34 of the hollow shaft 12, wherein it is in particular provided that an inner circumferential surface 34 of the hollow shaft 12 has an encircling recess 32 and the oil channels 30 open out into said recess 32. The recess 30 ensures to a pronounced extent that, during operation and as a result of the prevailing centrifugal force, lubricating oil is collected and is driven outward via the oil channels 30 so as to pass to the axial contact surfaces 20, 22, and to oil the latter, after exiting the oil channels 30. In order for the lubricating oil to be fed as fully as possible to the axial contact surfaces 20, 22 after exiting the oil channels 30, a seal 28 arranged between an inner circumferential surface of the radial shoulder 36 and the inner hub element 12 is advantageously provided.

FIG. 3 shows an alternative configuration of the shaft-hub connection 10, which can be used in particular in the case of an oppositely directed main force direction F. This occurs when the angle of the helical toothing in relation to the main axis of rotation A_{R} is configured oppositely. The outer hub element 14 is substantially identical to the variant shown in FIG. 2, wherein in the present case the axial contact surface 22 is arranged on the opposite axial flank. Correspondingly, the radial shoulder 24 is formed by an abutment ring 40 which is attached to the inner hub element 12 at one end, wherein the abutment ring 40 and the hub element 12 are situated coaxially with respect to one another. The axial contact surface 22 of the hub element 12 is situated on that end side 44 of the abutment ring 40 which faces toward the radial shoulder 24. The abutment ring 40 is screwed to the shaft end of the hub element 12 via a screw connection 42 (the latter being merely indicated). It can be seen that the oil channels 30 are formed by radial recesses 46 extending on the end side 44 of the abutment ring 40. Alternatively or additionally, the recesses 46 may also extend on an end face 18 of the hub element 12, this not however being Illustrated in the present case, The oil channels 30 are extended radially outward to such an extent that they cover the axial contact surface 22 in the radial direction.

FIG. 4 shows a structural setup of a further configuration of a shaft-hub connection 10. The shaft-hub connection 10 is provided in the present case as a drive connection between a first planetary stage 4 and a second planetary stage 6, which are symbolized in the present case by the two arrows and the reference signs 4 and 6. Of the planetary stage 4, only a sun shaft SW is shown, wherein the sun shaft is designed as an outer hub element 14 of the shaft-hub connection 10. Of the planetary stage 6 that follows, only a planet carrier PLT is schematically shown, wherein the planet carrier PLT is designed as an inner hub element 12 of the shaft-hub connection 10. As described in relation to FIG. 2, provision is made of a securing ring 38 which supports the hub element 12 with respect to a flank of the radial shoulder 36 that is at the rear in relation to the axial contact surface 22. Otherwise, with regard to the further structural setup of the shaft-hub connection 10 and with regard to the configuration of the pairing of the axial contact surfaces 20, 22 and the oiling that takes place radially from the inside, reference is made to the description relating to FIGS. 1 to 3.

FIG. 5 shows an alternative to the structural setup of the shaft-hub connection 10 in FIG. 4. In this case, the axial contact surface 20, 22 of the inner hub element 12 is formed on a second securing ring 48 which engages circumferentially around the inner hub element 12. Otherwise, here too, reference is made to the description relating to FIGS. 1 to 4.

FIG. 6 shows a purely exemplary planetary transmission 2, for example for a wind turbine. A first and a second rotating planetary stage 4, 6 and a spur-gear stage 8 are accommodated in succession in a transmission housing 3. In the present case, a shaft-hub connection 10 is provided as a drive connection between the second planetary stage 6 and the spur-gear stage 8. It may be provided that the second planetary stage 6 is designed to rotate more rapidly than the first planetary stage 4.

An embodiment of a wind turbine 70 is illustrated in FIG. 7. The wind turbine 70 comprises a nacelle 71 on which a multi-blade rotor 72 is mounted in a rotatable manner. The multi-blade rotor 72 is connected in a torque-transmitting manner to a main shaft 74, wherein the main shaft 74 belongs to a drive train 76. The drive train 76 further comprises a planetary transmission 2 which is connected in a torque-transmitting manner to the main shaft 74. The planetary transmission 2 has at least one planetary stage 6 and a spur-gear stage 8 and is coupled to a generator 80. In the present case, a shaft-hub connection 10 is provided as a drive connection between the planetary stage 6 and the spur-gear stage 8, wherein the shaft-hub connection 10 may be designed as described above.

### LIST OF REFERENCE SIGNS

2 Planetary transmission
3 Transmission housing
4 Planetary stage
6 Planetary stage
8 Spur-gear stage
10 Shaft-hub connection
12 Hollow shaft
14 Hub element
16 Spline toothing
18 End face
20 Axial contact surface
22 Axial contact surface
24 Radial shoulder
26 Foot region
28 Seal
30 Oil channel
32 Recess
34 Inner circumferential surface
36 Radial shoulder
38 Securing ring
40 Abutment ring
42 Screw connection
44 End side
46 Recess
48 Securing ring
50 Outlet mouth
70 Wind turbine
71 Nacelle
72 Multi-blade rotor
74 Main shaft
76 Drive train
80 Generator

What is claimed is:

1-15. (canceled)

16. A shaft-hub connection for a planetary transmission, the shaft-hub connection comprising:
an inner hub element;
an outer hub element connected via a spline toothing in driving relationship with the inner hub element about a main axis of rotation and surrounding the inner hub element at an outer circumference, with the inner hub element and the outer hub element bearing against one another via a pairing of axial contact surfaces; and
an oil channel formed by the inner hub element in a region of an axial position of the axial contact surfaces for oiling of the axial contact surfaces, said oil channel opening out radially within the axial contact surfaces via an outlet mouth.

17. The shaft-hub connection of claim 16, wherein the oil channel opens out In a geometry which extends circumferentially on an inner circumferential surface of the inner hub element.

18. The shaft-hub connection of claim 16, further comprising a plurality of said oil channel distributed in a circumferential manner.

19. The shaft-hub connection of claim 16, wherein the oil channel in the inner hub element has a radial profile or a profile which is inclined axially with respect to a radial direction.

20. The shaft-hub connection of claim 16, wherein the axial contact surface of the inner hub element is formed on a radial shoulder of the inner hub element, said oil channel opening out into a region of the radial shoulder.

21. The shaft-hub connection of claim 20, further comprising an abutment ring forming the radial shoulder and attached coaxially to the inner hub element at one end of the inner hub element.

22. The shaft-hub connection of claim 21, wherein the abutment ring is held on the inner hub element at the one end via a screw connection.

23. The shaft-hub connection of claim 21, wherein the oil channel is formed by a geometry which extends radially on an end face of the inner hub element and/or on an end side of the abutment ring.

24. The shaft-hub connection of claim 21, wherein the oil channel and an encircling geometry are arranged in a separation plane between the inner hub element and the abutment ring.

25. The shaft-hub connection of claim 16, further comprising a securing ring on which the axial contact surface of the inner hub element is formed and which engages circumferentially around the inner hub element.

26. The shaft-hub connection of claim 16, further comprising a seal arranged between the inner hub element and the outer hub element with an axial offset to the oil channel.

27. The shaft-hub connection of claim 16, further comprising a surface profiling applied at least to one of the axial contact surfaces.

28. A transmission for a wind turbine, the transmission comprising:
a planetary stage;
an outer hub element; and
a shaft-hub connection for providing a driving relationship between the planetary stage or multiple planetary stages and the outer hub element, said shaft-hub connection comprising an inner hub element connected via a spline toothing in driving relationship with the outer hub element for rotation of the inner and outer hub elements about a main axis of rotation, with the outer hub element surrounding the inner hub element at an outer circumference, wherein the inner hub element and the outer hub element bear against one another via a pairing of axial contact surfaces, and an oil channel formed by the inner hub element in a region of an axial position of the axial contact surfaces for oiling of the axial contact surfaces, said oil channel opening out radially within the axial contact surfaces via an outlet mouth.

29. A drive train for a wind turbine, the drive train comprising:
a transmission comprising a planetary stage, an outer hub element, and a shaft-hub connection for providing a driving relationship between the planetary stage or multiple planetary stages and the outer hub element, said shaft-hub connection comprising an inner hub element connected via a spline toothing in driving relationship with the outer hub element for rotation of the inner and outer hub elements about a main axis of rotation, with the outer hub element surrounding the inner hub element at an outer circumference, wherein the inner hub element and the outer hub element bear against one another via a pairing of axial contact surfaces, and an oil channel formed by the inner hub element in a region of an axial position of the axial contact surfaces for oiling of the axial contact surfaces, said oil channel opening out radially within the axial contact surfaces via an outlet mouth;
a rotor shaft connected in a torque transmitting manner to the transmission; and
a generator connected in a torque-transmitting manner to the transmission.

30. A wind turbine; comprising:
a nacelle;
the drive train of claim 29; and
a multi-blade rotor arranged on the nacelle in a rotatable manner and connected to the drive train in a torque-transmitting manner.
